(19) United States
(12) Patent Application Publication
(10) Pub. No.: US 2012/0200476 A1
(43) Pub. Date: Aug. 9, 2012

(54) HEAD-UP DISPLAY UNIT

(75) Inventors: Naohito Kanamori, Yokkaichi-city (JP); Yayoi Yonemoto, Nagoya-city (JP)

(73) Assignee: DENSO CORPORATION, Kariya-city (JP)

(21) Appl. No.: 13/362,312

(22) Filed: Jan. 31, 2012

(30) Foreign Application Priority Data
Feb. 4, 2011 (JP) 2011-23049

(51) Int. Cl. G09G 5/00

(52) U.S. Cl. 345/7

(57) ABSTRACT

A head-up display unit produces a first image representing first information and a second image representing second information floating in space by projecting light, emitted from a light source, toward a transparent projection member. The head-up display unit includes a first image generator and a second image generator. The first image generator has a first light transmission portion corresponding to the first image and generates a first image light, for producing the first image, by causing the light emitted from the light source to be transmitted through the first light transmission portion in a first direction. The second image generator is arranged parallel to the first image generator in a second direction crossing the first direction. The second image generator generates and outputs a second image light, for producing the second image, in a third direction along the first direction.

### CROSS REFERENCE TO RELATED APPLICATION

This application is based on and claims priority to Japanese Patent Application No. 2011-23049 filed on Feb. 4, 2011, the contents of which are incorporated by reference.

### FIELD OF INVENTION

The present invention relates to a head-up display unit for producing an image representing information floating in space by projecting light emitted from a light source toward a projection member such as a windshield of a vehicle.

### BACKGROUND OF INVENTION

JP-6-68956U discloses a head-up display unit that shows information to an occupant of a vehicle by producing an information image floating in space ahead of a windshield of the vehicle. The head-up display unit includes a display device such as a liquid crystal display device and a fluorescent tube as a light source. The display device forms a display image corresponding to the information image produced in the space. The fluorescent tube emits light, and the light is transmitted through the display image formed by the display device so that an image light for producing the information image can be generated.

US 2009/0231116A, corresponding to JP-2009-217682A, discloses an in-vehicle display device for displaying information dots on a windshield of a vehicle. The display device includes point light sources, each of which outputs light to display a corresponding information dot on the windshield.

As described above, in the conventional head-up display unit disclosed in JP-6-68956U, the image light for producing the information image is transmitted through the display device. Therefore, depending on the light transmittance of the display device, the brightness of the information image produced by the image light may be insufficient to attract the attention of the occupant. In contract, in the conventional in-vehicle display device disclosed in US 2009/0231116A, the lights emitted from the point light sources are directly projected on the windshield. Therefore, it is likely that the brightness of the information dots displayed on the windshield is enough to attract the attention of the occupant.

The present inventors have considered to develop an apparatus for displaying a first image such as the information image disclosed in JP-6-68956U along with a second image of high brightness such as the information dots disclosed in US 2009/0231116A. However, when the apparatus is formed by simply combining the conventional head-up display unit and the conventional in-vehicle display device, the size of the apparatus is much increased.

Further, when the apparatus is formed by simply combining the conventional head-up display unit and the conventional in-vehicle display device, first light for producing the first image and second light for producing the second image are emitted from different positions in different directions. Therefore, the first and second lights travel though different optical paths and produce the first and second images in space. As a result, the distance of the optical path from the windshield to the first image becomes different from the distance of the optical path from the windshield to the second image. Therefore, the first image and the second image cannot be displayed adjacent to each other, and the occupant needs to move the viewpoint largely to recognize both the first image and the second image.

### SUMMARY OF INVENTION

In view of the above, it is an object of the present invention to provide a relatively small-sized head-up display unit for displaying first and second images of different brightness in such a manner that a user can easily recognize the first and second images.

According to an aspect of the present invention, a head-up display unit produces a first image representing first information and a second image representing second information floating in space by projecting light, emitted from a light source, toward a transparent projection member. The head-up display unit includes a first image generator and a second image generator. The first image generator has a first light transmission portion corresponding to the first image and generates a first image light, for producing the first image, by causing the light emitted from the light source to be transmitted through the first light transmission portion in a first direction. The second image generator is arranged parallel to the first image generator in a second direction crossing the first direction. The second image generator generates and outputs a second image light, for producing the second image, in a third direction along the first direction.

### BRIEF DESCRIPTION OF THE DRAWINGS

The above and other objects, features, and effects will become more apparent from the following description and drawings in which like reference numerals depict like elements. In the drawings:

FIG. 1 is a diagram illustrating an interior of a vehicle equipped with a head-up display unit according to an embodiment of the present invention;

FIGS. 2A-2C are diagrams illustrating information images projected by the head-up display unit;

FIG. 3 is a diagram illustrating a manner in which light projected by the head-up display unit produces images in space;

FIG. 4 is a diagram illustrating a cross-sectional view of an inner casing of the head-up display unit;

FIG. 5 is a block diagram of the head-up display unit;

FIG. 6 is a diagram illustrating an enlarged view of a portion indicated by a dot line circle VI in FIG. 4;

FIG. 7 is a flow chart of a control process executed by a controller of the head-up display unit;

FIG. 8 is a diagram corresponding to FIG. 6 and illustrating a head-up display unit according to a modification of the embodiment; and

FIG. 9 is a diagram corresponding to FIG. 6 and illustrating a head-up display unit according to another modification of the embodiment.

### DETAILED DESCRIPTION OF THE PREFERRED EMBODIMENT

A head-up display unit 100 according to an embodiment of the present invention is described below with reference to the drawings.

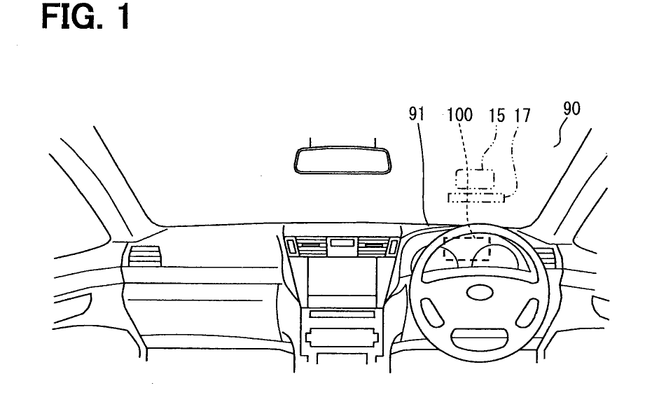

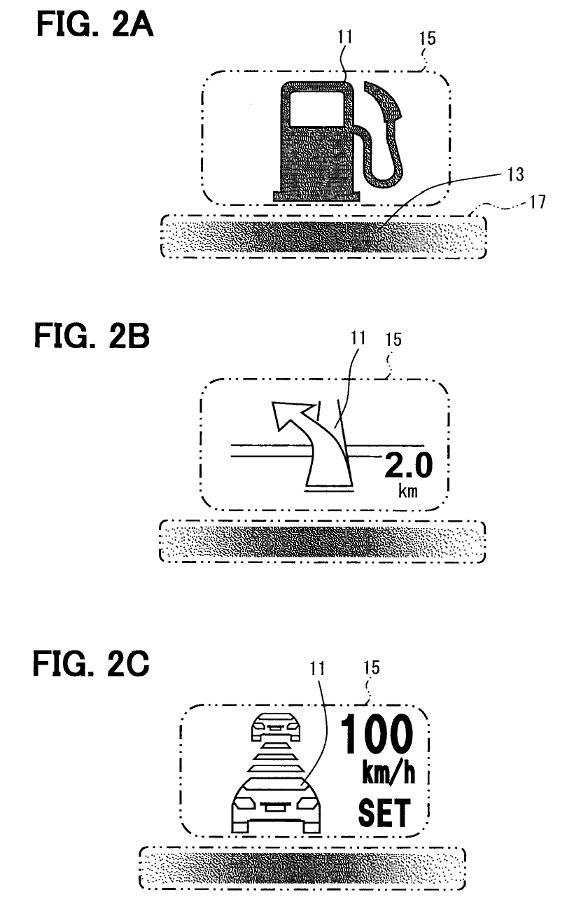

As shown in FIG. 1, the head-up display unit 100 is installed in an instrument panel 91 of a vehicle. The head-up display unit 100 projects light on a transparent projection member such as a windshield 90 of the vehicle to produce an image in space ahead of the windshield 90 outside the vehicle. For example, the produced image can include an information image 11 and an indicator image 13 shown in FIGS. 2A-2C.

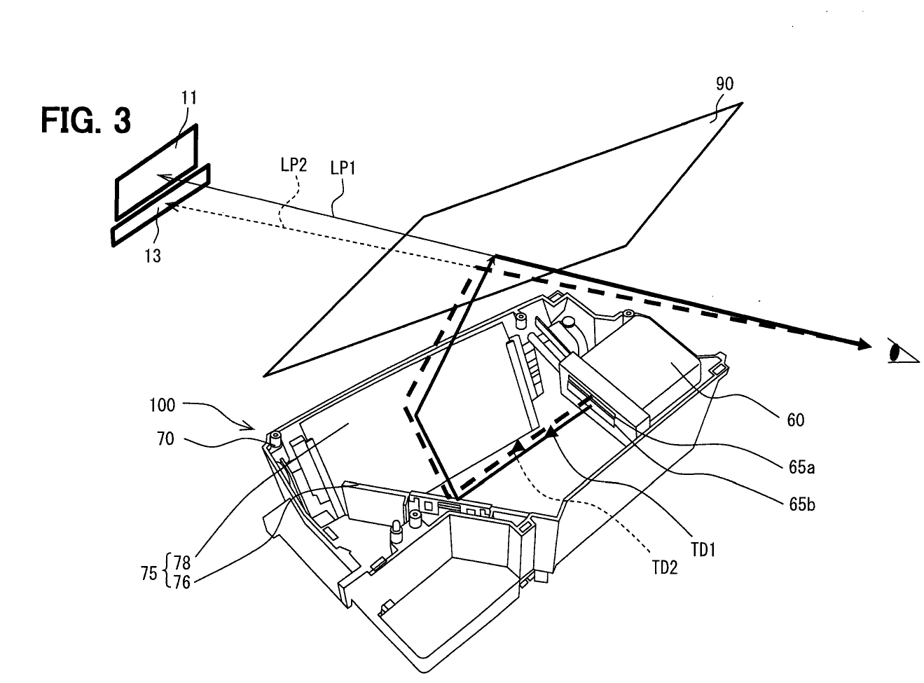

Specifically, the head-up display unit 100 projects first and second lights on a predetermined information projection area 15 and a predetermined indicator projection area 17 of the windshield 90 to produce the information image 11 and the indicator image 13, respectively. As shown in FIG. 3, the first light, indicated by a solid line, and the second light, indicated by a broken line, are reflected by the windshield toward a driver's seat in the vehicle. The reflected lights are received by a user (e.g., driver) seated on the driver's seat so that the user can see the information image 11 produced ahead of the information projection area 15 and the indicator image 13 produced ahead of the indicator projection area 17.

As shown in FIG. 2A, the information image 11 projected in the information projection area 15 can be displayed as fuel information warning that a remaining amount of fuel in a fuel tank of the vehicle is low. Further, as shown in FIG. 2B, the information image 11 can be displayed as navigation information representing a heading direction of the vehicle instructed by a navigation system. Furthermore, as shown in FIG. 2C, the information image 11 can be displayed as ACC information representing an operating status of an adaptive cruise control (ACC) system that allows the vehicle to track another vehicle ahead of the vehicle.

The indicator projection area 17 is located below the information projection area 15 in a vertical direction of the vehicle. The indicator image 13 projected in the indicator projection area 17 has a narrow rectangular shape, like a strip, extending in a horizontal direction of the vehicle. The indicator image 13 is displayed adjacent to the information image 11 at higher brightness than the information image 11 in order to guide a line of sight of the user to the information image 11. For example, the indicator image 13 can be displayed in orange color, which has a higher attention value. The indicator image 13 can be continuously displayed. Alternatively, the indicator image 13 can be intermittently displayed to flash or blink. The indicator image 13 attracts and guides the line of sight of the user to the information image 11 so that the user can quickly recognize the information represented by the information image 11.

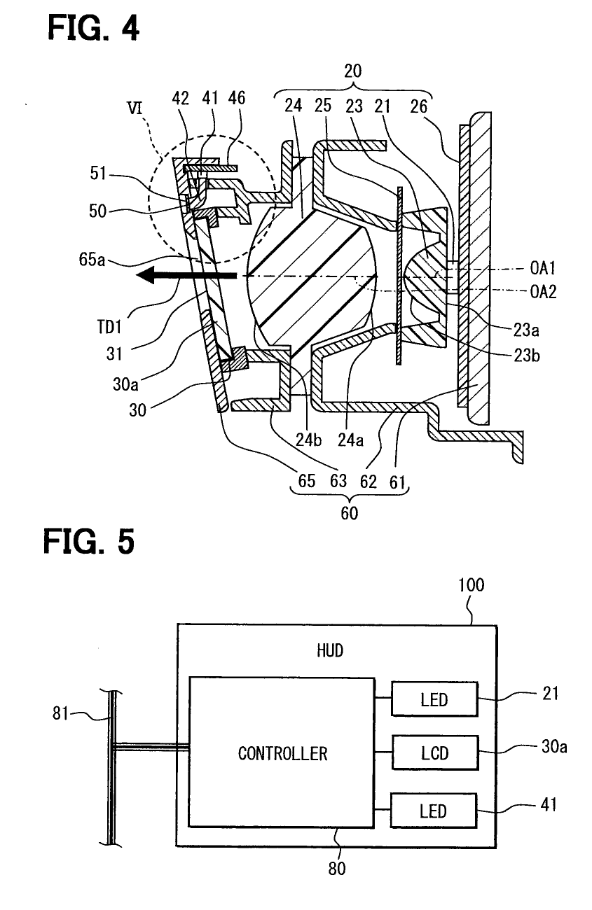

Next, a basic configuration of the head-up display unit 100 is described with reference to FIGS. 3 and 4.

The head-up display unit 100 includes a liquid crystal display panel illuminator 20, an image generator 30, an inner casing 60, a reflector 75, and an outer casing 70.

The liquid crystal display panel illuminator 20 includes a primary board 26, a light emitting diode 21, a first lens 23, a diffuser panel 25, and a second lens 24. The primary board 26 is a circuit board shaped like a plate. The primary board 26 is supported by the inner casing 60. Multiple light emitting diodes 21 are mounted on a mounting surface of the primary board 26 to face the first lens 23. The light emitting diode 21 is a light source for emitting light supplied to the image generator 30. For example, the light emitting diode 21 emits white light toward the first lens 23 when a current is applied to the light emitting diode 21.

The first lens 23, the diffuser panel 25, and the second lens 24 are made of a transparent resin material such as acrylic resin or polycarbonate resin. The first lens 23 and the second lens 24 are fixed to the inner casing 60 in such a manner that an optical axis OA1 of the first lens 23 can coincide with an optical axis OA2 of the second lens 24. The first lens 23 has a planer light incident surface 23a and a convex light emission surface 23b. The light incident surface 23a extends along the mounting surface of the primary board 26, where the light emitting diode 21 is mounted. The light emitted from the light emitting diode 21 enters the first lens 23 from the light incident surface 23a and exits the first lens 23 from the light emission surface 23b. The light exited from the light emission surface 23b is refracted by the light emission surface 23b toward the second lens 24.

The diffuser panel 25 is shaped like a plate. A micro asperity (sometimes referred to as texture or grain) is formed on each surface of the diffuser panel 25. The diffuser panel 25 is located between the first lens 23 and the second lens 24. The light exited from the light emission surface 23b of the first lens 23 is diffused by the micro asperity of the diffuser panel 25. The diffuser panel 25 reduces a variation in brightness of the light exited from the light emission surface 23b of the first lens 23 and outputs the light toward the second lens 24.

The second lens 24 has a convex light incident surface 24a and a convex light emission surface 24b. The light passing through the diffuser panel 25 enters the second lens 24 from the light incident surface 24a while being converged by the light incident surface 24a. The converged light exits the second lens 24 from the light emission surface 24b and is refracted by the light emission surface 24b in a direction along the optical axis OA2 of the second lens 24.

The image generator 30 includes a dot matrix liquid crystal display (LCD) panel 30a. The liquid crystal display panel 30a is shaped like a plate and has a longitudinal direction. The liquid crystal display panel 30a controls multiple pixels arranged along a surface direction of a display screen to produce a display image 31 corresponding to the information image 11 as a light transmission portion. The liquid crystal display panel 30a allows light emitted from the liquid crystal display panel illuminator 20 to be transmitted through the display image 31 so that light for producing the information image 11 can be generated. A thickness direction of the liquid crystal display panel 30a is slightly inclined with respect to the optical axis OA1 of the first lens 23 and the optical axis OA2 of the second lens 24. The light transmitted through the display image 31 moves in a transmission direction TD1 along the optical axis OA1 of the first lens 23 and the optical axis OA2 of the second lens 24.

The liquid crystal display panel illuminator 20 and the image generator 30 are accommodated in the inner casing 60. The inner casing 60 is accommodated in the outer casing 70 and fixed to the outer casing 70. The inner casing 60 includes a rear cover 61, a rear casing part 62, a front casing part 63, and a front plate 65. The rear cover 61, the rear casing part 62, the front casing part 63, and the front plate 65 are made of a transparent resin material.

The rear cover 61 supports the primary board 26. The rear casing part 62 is located in the transmission direction TD1 with reference to the rear cover 61. The rear casing part 62 supports the first lens 23 and the diffuser panel 25. The front casing part 63 is located in the transmission direction TD1 with reference to the rear casing part 62. The front casing part 63 works in conjunction with the rear casing part 62 to support the second lens 24. The front plate 65 is located in the transmission direction TD1 with reference to the front casing part 63. The front plate 65 works in conjunction with the front casing part 63 to support the liquid crystal display panel 30a. A first transmission window 65a is formed in the front plate 65. The light exited from the image generator 30 moves in the transmission direction TD1 and is transmitted through the first transmission window 65a.

The reflector 75 is accommodated in the outer casing 70 and fixed to the outer casing 70. The reflector 75 includes a plane mirror 78 and a concave mirror 76. The plane mirror 78 and the concave mirror 76 are formed by depositing metal such as aluminum on a base plate made of a transparent resin material, glass, or the like. The plane mirror 78 has a planar reflecting surface. The plane mirror 78 reflects the light exited from the image generator 30 toward the concave mirror 76.

The concave mirror 76 faces the plane mirror 78 and has a concave reflecting surface that curves with respect to the plane mirror 78. The concave reflecting surface of the concave mirror 76 is curved to correct distortions of the information image 11 and the indicator image 13 due to curvature of the windshield 90. The concave mirror 76 reflects the light reflected by the plane mirror 78 toward the windshield 90.

The outer casing 70 is made of a resin material. The inner casing 60 and the reflector 75 are accommodated in the outer casing 70. The outer casing 70 determines a relative position between the inner casing 60 and the reflector 75 so that the information image 11 and the indicator image 13 can be produced in correct positions.

Next, an electrical configuration of the head-up display unit 100 is described with reference to FIG. 5.

The head-up display unit 100 includes a controller 80. The controller 80 has a processor for executing programs, a flash memory for storing the programs and image data for the display image 31 (refer to FIG. 4), and a random access memory (RAM) where the processor executes the programs.

The controller 80 is connected to an in-vehicle local area network (LAN) 81. The in-vehicle LAN 81 is connected to various devices, including the navigation system, a fuel sensor, and the ACC system, mounted on the vehicle. The controller 80 obtains vehicle information including the fuel information, the navigation information, and the ACC information, through the in-vehicle LAN 81.

The controller 80 is connected to the light emitting diode 21 and the liquid crystal display panel 30a. The controller 80 controls the light emitted from light emitting diode 21 by applying the current to the light emitting diode 21 based on the vehicle information. Further, the controller 80 displays the display image 31 (refer to FIG. 4) on the liquid crystal display panel 30a by controlling the pixels of the liquid crystal display panel 30a based on the vehicle information.

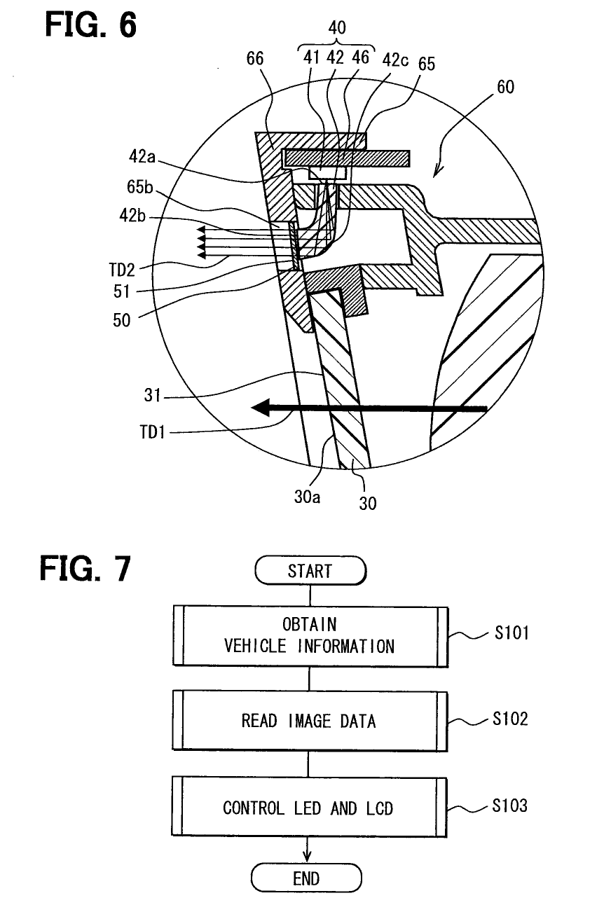

The head-up display 100 according to the embodiment is described in further detail below with reference to FIGS. 3 and 6.

The head-up display unit 100 includes an indicator illuminator 40 and an indicator film 50.

The indicator illuminator 40 includes a secondary board 46, a light emitting diode 41, and a light guide prism 42. The secondary board 46 is a circuit board and has a narrow rectangular shape, like a strip, extending in a longitudinal direction of the liquid crystal display panel 30a. The secondary board 46 is fixed to the inner casing 60. Multiple light emitting diode 41 are mounted on a mounting surface of the secondary substrate 46. The mounting surface of the secondary substrate 46 faces the light guide prism 42.

The light emitting diode 41 is a light source for emitting light supplied to the indicator film 50. For example, the light emitting diode 41 emits white light when a current is applied to the light emitting diode 41. The light emitting diodes 41 are arranged on the mounting surface of the secondary substrate 46 in the longitudinal direction of the liquid crystal display panel 30a. The light emitting diode 41 emits light toward the light guide prism 42. Like the light emitting diode 21 (refer to FIG. 4), the light emitting diode 41 is connected to the controller 80 (refer to FIG. 5). The light emitted from the light emitting diode 41 is controlled based on the current applied by the controller 80 to the light emitting diode 41.

The light guide prism 42 guides the light emitted from the light emitting diode 41 to the indicator film 50. The light guide prism 42 is made of a transparent resin material such as acrylic resin or polycarbonate resin. The light guide prism 42 has a light incident surface 42a, a light exit surface 42b, and a body 42c. The light incident surface 42a faces the mounting surface of the secondary board 46 and extends in the longitudinal direction of the liquid crystal display panel 30a. The light exit surface 42b extends in a direction along the display screen of the liquid crystal display panel 30a and faces in the transmission direction TD1. The light exit surface 42b faces the indicator film 50 and extends in the longitudinal direction of the liquid crystal display panel 30a. The light emitted from the light emitting diode 41 enters the body 42c from the light incident surface 42a in a direction crossing the transmission direction TD1 and is guided by the body 42c in a transmission direction TD2 along the transmission direction TD1. Thus, the light guide prism 42 outputs the light emitted from the light emitting diode 41 from the light exit surface 42b in the transmission direction TD2.

The indicator film 50 is arranged parallel to the image generator 30 in a direction perpendicular to the transmission direction TD1. The indicator film 50 is supported by the inner casing 60. The indicator film 50 has a narrow rectangular shape like a strip and extends along an outer edge of the liquid crystal display panel 30a in the longitudinal direction of the liquid crystal display panel 30a. The indicator film 50 is a thin plate and made of a transparent resin material. An orange light transmission portion 51 is formed on the indicator film 50 by a printing process or the like.

The orange light transmission portion 51 corresponds to a display mode of the indicator image 13. The display mode is a manner in which the indicator image 13 is displayed and includes a display color and a display shape. A light transmission rate of the orange light transmission portion 51 is higher than a light transmission rate of the display image 31 formed by the liquid crystal display panel 30a. Specifically, the orange light transmission portion 51 is formed by applying two prints on a base of the indicator film 50. One print is a transparent black print, and the other print is a transparent print that transmits light mainly over a predetermined range of frequencies that is visible as orange. The prints of the orange light transmission portion 51 gradually changes in color from orange to black from the center toward the ends of the orange light transmission portion 51 along the extension direction of the orange light transmission portion 51. Thus, the indicator image 13 (refer to FIG. 2A, for example) has a gradation in brightness from the center toward the ends in the horizontal direction. Specifically, the indicator image 13 gradually decreases in brightness from the center toward the ends in the horizontal direction.

The indicator film 50 causes the light, which is emitted from the light emitting diode 41 and guided by the light guide prism 42, to be transmitted through the orange light transmission portion 51. The transmission direction TD2 of the light that is transmitted through the orange light transmission portion 51 is along the transmission direction TD1 of the light that is transmitted through the display image 31 formed by the liquid crystal display panel 30a.

A second transmission window 65b and a secondary board supporting portion 66 are formed in the front plate 65 of the inner casing 60. The second transmission window 65b is an opening having a narrow rectangular shape like a strip and extending in the longitudinal direction of the liquid crystal display panel 30a. The indicator film 50 is fitted in the second transmission window 65b. Thus, the indicator film 50 is supported by the front plate 65 in a position that allows the indicator film 50 to emit light for producing the indicator image 13 in the transmission direction TD2 along the transmission direction TD1. The light emitted from the indicator film 50 is transmitted through the second transmission window 65b in the transmission direction TD2. The secondary board supporting portion 66 extends along an extension direction of the second transmission window 65b and is formed on an outer edge of the front plate 65 located closest to the second transmission window 65b. The secondary board supporting portion 66 supports the secondary board 46.

Next, a control process performed in the head-up display unit 100 to display the information image 11 and the indicator image 13 is described with reference to FIG. 7. The control process is performed by the controller 80 when the head-up display unit 100 is activated by the user, for example. The controller 80 repeats the control process until the head-up display unit 100 is deactivated.

The control process starts at S101, where the controller 80 obtains the vehicle information to be displayed as the information image 11 through the in-vehicle LAN 81. Then, the control process proceeds to S102, where the controller 80 reads image data of the display image 31, corresponding to the vehicle information obtained at S101, from the flash memory. Then, the control process proceeds to S103, where the controller 80 applies the currents to the light emitting diodes 21, 41 and controls the pixels of the liquid crystal display panel 30a based on the image data read at S102. Then, the control process is finished.

When the controller 80 executes 5103, the display image 31 is formed on the liquid crystal panel display 30a on the principle shown in FIGS. 3-5. Further, the image generator 30 generates the light for producing the information image 11 by using the light emitted from the light emitting diode 21 and outputs the generated light in the transmission direction TD1. Further, the indicator film 50 generates the light for producing the indicator image 13 by using the light emitted from the light emitting diode 41 and outputs the generated light in the transmission direction TD2.

The light for producing the information image 11 and the light for producing the indicator image 13 are emitted from the image generator 30 and the indicator film 50, which are arranged parallel to each other, in the transmission direction TD1 and the transmission direction TD2, respectively. These lights travel through substantially the same optical path constructed with the plane mirror 78, the concave mirror 76, and the window shield 90 and produce the information image 11 and the indicator image 13, which are arranged adjacent to each other, in space. The information image 11 and the indicator image 13 remains displayed until the vehicle information obtained at S101 disappears on the in-vehicle LAN 81 or until the controller 80 obtains another vehicle information.

According to the present embodiment, a distance LP1 (refer to a solid line arrow in FIG. 3) of an optical path from the windshield 90 to the information image 11 is equal to a distance from the windshield 90 to the image generator 30 through the concave mirror 76 and the plane mirror 78. Further, a distance LP2 (refer to a broken line arrow in FIG. 3) of an optical path from the windshield 90 to the indicator image 13 is equal to a distance from the windshield 90 to the indicator film 50 through the concave mirror 76 and the plane mirror 78. Since the lights emitted from the image generator 30 and the indicator film 50 travels through substantially the same optical path, a difference between the distance LP1 and the distance LP2 is reduced. Therefore, the user can recognize the information image 11 and the indicator image 13 with less movement of viewpoint.

Further, the image generator 30, which generates the light for producing the information image 11, and the indicator film 50, which generates the light for producing the indicator film 50, are arranged parallel to each other in the direction perpendicular to the transmission direction TD1. Thus, although the heat-up display unit 100 is configured to produce not only the information image 11 but also the indicator image 13 in space, an increase in size of the heat-up display unit 100 is prevented as much as possible.

Therefore, although the heat-up display unit 100 has a relatively small size, the heat-up display unit 100 displays the information image 11 and the indicator image 13 of different brightness levels so that the user can easily recognize the information image 11 and the indicator image 13.

Further, according to the present embodiment, the heat-up display unit 100 has two separate light sources, i.e., the light emitting diode 21 for emitting the light supplied to the image generator 30 and the light emitting diode 41 for emitting the light supplied to the indicator film 50. In such an approach, the indicator image 13 can be surely displayed at higher brightness than the information image 11 by setting the brightness of the light emitting diode 41 higher than the brightness of the light emitting diode 21. Thus, the heat-up display unit 100 displays the information image 11 and the indicator image 13, which has higher brightness than the information image 11, in such a manner that the user can easily recognize the information image 11 and the indicator image 13.

Further, according to the present embodiment, the light emitting diode 21 and the light emitting diode 41 are controlled by a common controller 80. Thus, as compared to when the light emitting diode 21 and the light emitting diode 41 are controlled by separate controllers, the heat-up display unit 100 can be reduced in size.

Further, since the light emitting diode 21 and the light emitting diode 41 are controlled by a common controller 80, the information image 11 and the indicator image 13 can be surely displayed at their right timings. Thus, although the heat-up display unit 100 has a relatively small size, the heat-up display unit 100 can display the information image 11 and the indicator image 13 at the right timings so that the user can easily recognize the information image 11 and the indicator image 13.

Further, according to the present embodiment, the light emitted from the light emitting diode 41 is surely guided by the light guide prism 42 to the orange light transmission portion 51. In such an approach, the indicator film 50 can be arranged near the image generator 30 regardless of where the light emitting diode 41 is located. Therefore, although the heat-up display unit 100 includes the indicator film 50, the increase in size of the heat-up display unit 100 can be prevented as much as possible.

Further, the light guide prism 42 cause the light emitted from the light emitting diode 41 to be transmitted through the orange light transmission portion 51 by changing the traveling direction of the light emitted from the light emitting diode 41 to the transmission direction TD2 along the transmission direction TD1 in which the light is transmitted through the image generator 30. Thus, it is ensured that the light transmitted through the orange light transmission portion 51 travels through substantially the same optical path as the light transmitted through the display image 31. Therefore, the user can recognize both the information image 11 and the indicator image 13 with less movement of point of sight. Therefore, although the heat-up display unit 100 has a relatively small size, the heat-up display unit 100 can display the information image 11 and the indicator image 13 in such a manner that the user can easily recognize the information image 11 and the indicator image 13.

Further, according to the present embodiment, the dot-matrix liquid crystal display panel 30a displays various types of display images 31. Thus, the head-up display unit 100 can display various types of information by changing the display mode (e.g., color and shape) of the information image 11 in various manners. As mentioned above, the light transmission rate of the display image 31 formed by the liquid crystal display panel 30a is lower than the light transmission rate of the orange light transmission portion 51 of the indicator film 50. Therefore, there is a concern whether the brightness of the information image 11 is sufficient to attract an attention of the user.

However, the light emitted from the indicator film 50 produces the indicator image 13 that is displayed adjacent to the information image 11 and displayed at higher brightness than the information image 11. Thus, the head-up display unit 100 is configured so that the indicator image 13 can attract the attention of the user and that the information image 11 can show the vehicle information to the user. As described above, the head-up display unit 100 includes the image generator 30 and the indicator film 50, and the information image 11 and the indicator image 13 work in conjunction with each other so that the vehicle information can be easily recognized by the user.

Further, according to the present embodiment, the indicator film 50 has a narrow rectangular shape like a strip and extends along the outer edge of the liquid crystal display panel 30a in the longitudinal direction of the liquid crystal display panel 30a. Thus, although the indicator film 50 is arranged parallel to the liquid crystal display panel 30a, the increase in size of the head-up display unit 100 can be prevented as much as possible. Further, since the indicator film 50 extends in a strip manner, the area of the orange light transmission portion 51 is increased so that the indicator image 13 can be increased. Thus, the indicator image 13 can surely attract the attention of the user. Therefore, although the head-up display unit 100 has a relatively small size, the information image 11 and the indicator image 13 work in conjunction with each other so that the vehicle information can be easily recognized by the user.

Further, according to the present embodiment, the inner casing 60 for holding the image generator 30 has the front plate 65 for holding the indicator film 50. In such approach, the transmission direction TD2 of the light emitted from the indicator film 50 can be accurately along the transmission direction TD1 in which the light is transmitted through the image generator 30. Thus, the information image 11 and the indicator image 13 are accurately arranged adjacent to each other and displayed in space. Therefore, the user can recognize both the information image 11 and the indicator image 13 with less movement of point of sight.

Since the inner casing 60 has the front plate 65 for holding the indicator film 50, the head-up display unit 100 does not need to have an additional holding member for holding the indicator film 50. Thus, the increase in size of the head-up display unit 100 can be prevented as much as possible. Therefore, although the heat-up display unit 100 has a relatively small size, the heat-up display unit 100 can display the information image 11 and the indicator image 13 in such a manner that the user can easily recognize the information image 11 and the indicator image 13.

The correspondence between the embodiment and claims is as follows. The information image 11 corresponds to a first image. The indicator image 13 corresponds to a second image. The light emitting diode 21 corresponds to a light source and a first light source. The image generator 30 corresponds to a first image generator. The display image 31 corresponds to a first light transmission portion. The light emitting diode 41 corresponds to a light source and a second light source. The light guide prism 42 corresponds to a light guide member. The indicator film 50 corresponds to a second image generator. The inner casing 60 corresponds to a casing. The front plate 65 corresponds to a supporting portion. The controller 80 corresponds to a controller. The windshield 90 corresponds to a projection member.

(Modifications)

The embodiment described above can be modified in various ways, for example, as follows.

In the above embodiment, the traveling direction of the light, which is emitted from the light emitting diode 41 in the direction crossing the transmission direction TD1, is changed by the light guide prism 42 to the transmission direction TD2 along the transmission direction TD1. It is noted that a light guide member for guiding the light, which is emitted from the light emitting diode 41, to the orange light transmission portion 51 is not limited to the light guide prism 42.

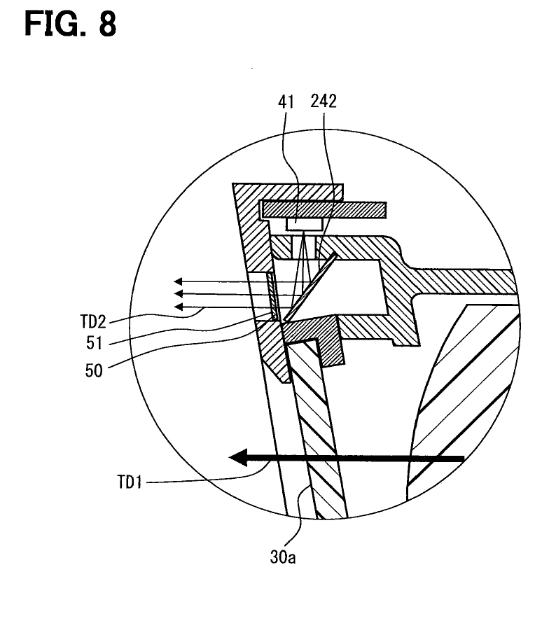

For example, as shown in FIG. 8, a reflector 242 can be used instead of the light guide prism 42. The reflector 242 is formed by depositing metal such as aluminum on a base plate made of glass or the like. The reflector 242 has a narrow rectangular shape like a strip and extends in the longitudinal direction of the liquid crystal display panel 30a. A reflecting surface of the reflector 242, where the metal is deposited, faces the light emitting diode 41 and the indicator film 50. The light emitted from the light emitting diode 41 in the direction crossing the transmission direction TD1 is reflected in the transmission direction TD by the reflecting surface of the reflector 242. Thus, the light emitted from the light emitting diode 41 is reflected by the reflector 242 and guided to the orange light transmission portion 51. Alternatively, the light guide member such as the light guide prism 42 or the reflector 242 can be removed from the head-up display unit 100 by placing a light emitting diode, as a second light source, on the opposite side to the transmission direction TD2.

In the embodiment, the light, which is emitted from the light emitting diode 41, is transmitted through the orange light transmission portion 51 of the indicator film 50 to generate the light for producing the indicator image 13. It is noted that a second image generator for outputting the light for producing the indicator image 13 in the transmission direction TD1 is not limited to the indicator film 50.

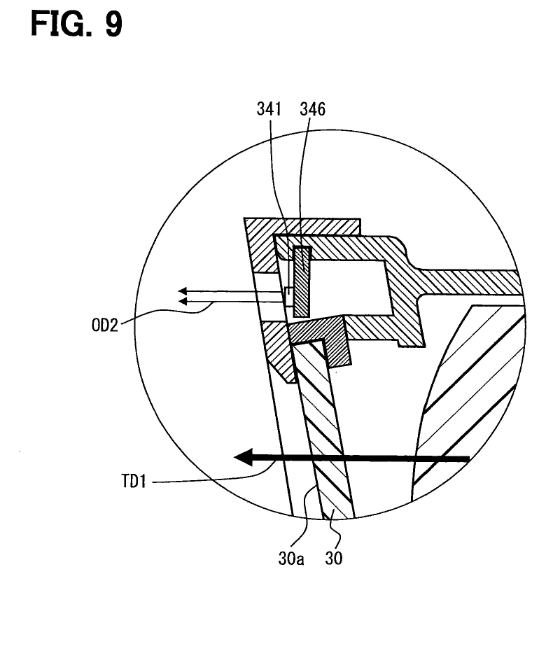

For example, as shown in FIG. 9, a secondary board 346 and multiple light emitting diodes 341, serving as a second light source and a second image generator, can be included in the head-up display unit 100. The secondary board 346 has a narrow rectangular shape like a strip and extends in the longitudinal direction of the liquid crystal display panel 30a. The secondary substrate 346 is arranged parallel to the image generator 30 in the direction perpendicular to the image generator 30. A mounting surface of the secondary board 346 faces the transmission direction TD1. The light emitting diodes 341 are mounted on the mounting surface of the secondary substrate 346 and arranged parallel to each other along the longitudinal direction of the liquid crystal display panel 30a. Thus, the light emitting diodes 341 can emit lights corresponding to the display mode of the indicator image 13 in an output direction OD2 along the transmission direction TD1. Alternatively, for example, a cold-cathode tube and an electroluminescence (EL) device for emitting the lights in the output direction OD2 along the transmission direction TD1 can be included in the head-up display unit 100 instead of the secondary board 346 and the light emitting diodes 341.

In the embodiment, the indicator film 50 is arranged parallel to the image generator 30 in the direction perpendicular to the transmission direction TD1. Alternatively, the indicator film 50 can be arranged parallel to the image generator 30 in a direction crossing the transmission direction TD1. For example, the image generator 30 can be displaced in the transmission direction TD1 with respect to the indicator film 50. For another example, the indicator film 50 can be displaced in the transmission direction TD1 with respect to the image generator 30.

In the embodiment, the heat-up display unit 100 has two separate light sources, i.e., the light emitting diode 21 for emitting the light supplied to the image generator 30 and the light emitting diode 41 for emitting the light supplied to the indicator film 50. Alternatively, the heat-up display unit 100 can have a common light source for emitting light supplied to each of the image generator 30 and the indicator film 50 in such a manner that the brightness of the indicator image 13 can be higher than the brightness of the information image 11.

In the embodiment, the light emitting diodes 21, 41 are used as a light source for emitting light. The light source is not limited to a light emitting diode. For example, a cold-cathode tube, an EL device, or a semiconductor laser can be used as the light source.

In the embodiment, the light emitting diodes 21, 41 are controlled by a common controller 80. Alternatively, the light emitting diodes 21, 41 can be independently controlled by separate controllers based on the vehicle information independently obtained through the in-vehicle LAN 81.

In the embodiment, the image generator 30 generates the display image 31 on the liquid crystal display panel 30a. Alternatively, the image generator 30 can generate the display image 31 without the liquid crystal display panel 30a. For example, like the indicator film 50, the image generator 30 can have a light transmission portion that is formed by applying a transparent print on a transparent base.

In the embodiment, the indicator film 50 extends like a strip in the longitudinal direction of the liquid crystal display panel 30a. The indicator film 50 is not limited to such a shape. For example, the indicator film 50 can extend like a strip in a direction perpendicular to the longitudinal direction of the liquid crystal display panel 30a. For another example, multiple indicator films 50 can be located along the outer edge of the liquid crystal display panel 30a.

In the embodiment, the indicator film 50 has the orange light transmission portion 51 for transmitting light mainly over a predetermined range of frequencies that is visible as orange. Alternatively, the indicator film 50 can have a light transmission portion for transmitting light mainly over a predetermined range of frequencies that is visible as color other than orange.

In the embodiment, the inner casing 60 accommodates the indicator illuminator 40 and the indicator film 50 in addition to the liquid crystal display panel illuminator 20 and the image generator 30. Alternatively, a casing for accommodating the indicator illuminator 40 and the indicator film 50 can be separate from a casing for accommodating the liquid crystal display panel illuminator 20 and the image generator 30, and these separate casings can be fixed to the outer casing 70.

In the embodiment, the head-up display unit 100 is configured to project the lights for producing the information image 11 and the indicator image 13 on the windshield 90. Alternatively, the head-up display unit 100 can be configured to project the lights for producing the information image 11 and the indicator image 13 on a transparent plate, such as a combiner, placed on an top surface of the instrument panel 91.

In the embodiment, the vehicle information displayed as the information image 11 includes the fuel information shown in FIG. 2A, the navigation information shown in FIG. 2B, and the ACC information shown in FIG. 2C. The information image 11 can show another vehicle information to the user. In the embodiment, the indicator image 13 serves to attract the attention of the user. Alternatively, the indicator image 13 can serve to not only attract the attention of the user but also to show information to the user. That is, the display modes, such as shape and color, of the information image 11 and the indicator image 13 can vary depending on the intended application.

Such changes and modifications are to be understood as being within the scope of the present invention as defined by the appended claims.

What is claimed is:

1. A head-up display unit for producing a first image representing first information and a second image representing second information floating in space by projecting light toward a transparent projection member, the head-up display unit comprising:
a light source configured to emit the light;
a first image generator having a first light transmission portion corresponding to the first image, the first image generator configured to generate a first image light, for producing the first image, by causing the light emitted from the light source to be transmitted through the first light transmission portion in a first direction; and
a second image generator arranged parallel to the first image generator in a second direction crossing the first direction, the second image generator configured to generate and output a second image light, for producing the second image, in a third direction along the first direction.

2. The head-up display unit according to claim 1, wherein
the light source includes a first light source for emitting first light and a second light source for emitting second light,
the first image generator generates the first image light by causing the first light to be transmitted through the first light transmission portion, and
the second image generator has a second light transmission portion corresponding to the second image and generates the second image light by causing the second light to be transmitted through the second light transmission portion,

3. The head-up display unit according to claim 2, further comprising:
a controller configured to control both the first light source and the second light source.

4. The head-up display unit according to claim 2, further comprising:
a light guide member configured to guide the second light emitted from the second light source to the second light transmission portion so that the guided second light is transmitted through the second light transmission portion in the third direction.

5. The head-up display unit according to claim 1, wherein
the first image generator includes a liquid crystal display panel configured to form the first light transmission portion.

6. The head-up display unit according to claim 5, wherein
the second image generator extends like a strip along an outer edge of the liquid crystal display panel.

7. The head-up display unit according to claim 1, further comprising:
a casing configured to accommodate the first image generator and including a supporting portion, wherein
the supporting portion supports the second image generator in a position that allows the second image generator to output the second image light in the third direction.

8. The head-up display unit according to claim 1, wherein
the transparent member is a windshield of e vehicle, and
the first image and the second image are produced ahead of the windshield toward the front of the vehicle.
